(19) United States
(12) Patent Application Publication
(10) Pub. No.: US 2001/0047644 A1
(43) Pub. Date: Dec. 6, 2001

(54) METHOD OF RAKING WITH A TRACTOR HAVING A REAR HYDRAULIC BLADE

(76) Inventor: EAMON E FEELEY, COLORADO SPRINGS, CO (US)

Correspondence Address: GLEN F GALLINGER, 7420 MILNER DRIVE, COLORADO SPRINGS, CO, 80920

(21) Appl. No.: 09/444,662

(22) Filed: Nov. 22, 1999

(51) Int. Cl. A01D 7/00; E02F 3/96

(52) U.S. Cl. 56/400.05; 56/400.04; 56/400.21; 37/407; 37/410

(57) ABSTRACT

A rake for attachment to a horizontally elongated blade on a tractor. After attachment the rake can be can be lifted, lowered, and pressed down into the soil or gravel etc. being raked with hydraulic power. The rake comprises comprises: a horizontally elongate member adapted to be carried adjacent, parallel to, and beneath the bottom portion of the blade; arms affixed along the elongate member for releasably attaching the member beneath the bottom portion of the blade; and, teeth spaced along and extending downwardly beneath the elongate member. In a preferred embodiment of this invention the elongated member comprises a channel, the blade attachment means comprises arms which extend from opposite side portions of the channel and surround the blade, and the teeth comprise hardened replaceable bolts.

### FIELD OF INVENTION

This invention relates to rakes used on tractors. More particularly this invention relates to a rake for attachment to a hydraulically operated blade on a tractor.

### BACKGROUND OF THE INVENTION

Tractors and other vehicles are frequently equipped with a hydraulic blade. The hydraulic blade can be lifted, lowered, and pressed down with hydraulic power. Generally the need for a rake is not as great as a blade and many tractors on which a rake could be used to advantage, already have a blade.

There is a need for a rake attachment for a blade on a tractor. Compared to the cost of a rake attachment for a tractor, the cost of a rake attachment to a blade is minimal. The blade itself can be used for support of the rake. Once a rake is attached to the blade the hydraulic controls of the blade can operate the rake. Installation onto a blade is quicker and easier than removing the blade and installing an entire rake to the tractor. The space required for storage of a blade attachment is a fraction of the space required for an entire rake. There is a real need for an inexpensive rake attachment for a tractor blade.

### OBJECTS AND STATEMENT OF INVENTION

It is an object of this invention to disclose a rake attachment for a blade. It is yet a further object of this invention to disclose an inexpensive and effective hydraulically controlled rake for a tractor having a blade. It is a further object of this invention to disclose a rake attachment for a tractor that will minimize storage space requirements.

One aspect of this invention provides for a rake for attachment to a horizontally elongated blade comprising: a horizontally elongated member adapted to be carried adjacent, parallel to, and beneath the bottom portion of the blade; a blade attachment means affixed along the elongate member for releasably attaching the member beneath the bottom portion of the blade; and, teeth spaced along and extending downwardly beneath the elongate member.

In a preferred embodiment of this invention the elongated member comprises a channel, the blade attachment means comprises arms which extend from opposite side portions of the channel and surround the blade, and the teeth comprise hardened replaceable bolts.

Various other objects, advantages and features of novelty which characterize this invention are pointed out with particularity in the claims which form part of this disclosure. For a better understanding of the invention, its operating advantages, and the specific objects attained by its users, reference should be made to the accompanying drawings and description, in which preferred embodiments of the invention are illustrated.

### FIGURES OF THE INVENTION

The invention will be better understood and objects other than those set forth will become apparent to those skilled in the art when consideration is given to the following detailed description thereof. Such description makes reference to the annexed drawings wherein:

FIG. 1 is a perspective view of a rake for attachment to a blade mounted on a tractor.

FIG. 2 is a cross sectional view of the rake as viewed along line 2-2 on FIG. 1.

The following is a discussion and description of the preferred specific embodiments of this invention, such being made with reference to the drawings, wherein the same reference numerals are used to indicate the same or similar parts and/or structure. It should be noted that such discussion and description is not meant to unduly limit the scope of the invention.

### DESCRIPTION OF THE INVENTION

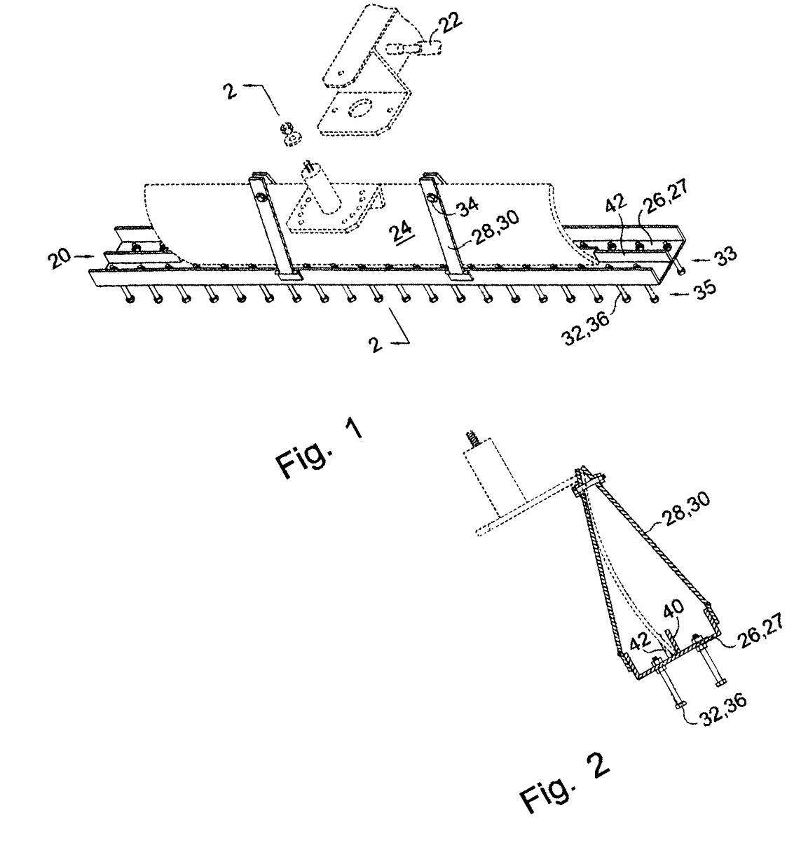

Turning now to the drawings and more particularly to FIG. 1 we have a perspective view of a rake 20 for attachment to a hydraulically 22 controlled blade 24 on a tractor (not shown). The rake 20 for attachment to a horizontally elongated blade 24 comprises: a horizontally elongated member 26 adapted to be carried adjacent, parallel to, and beneath the bottom portion of the blade 24; blade attachment means 28 affixed along the elongate member 26 for releasably attaching the member 26 beneath the bottom portion of the blade 24; and, teeth 32 spaced along and extending downwardly beneath the elongate member 26.

Most preferably the elongate member 26 comprises a channel 27. Most preferably the attachment means 28 comprise two upright arms 30, one extending from a front side portion of the elongate member 26, and one extending from a rear opposite side portion of the elongate member 26 so that when the blade 24 is seated on the elongate member 26 a top portion of the arms 30 may be held together around the blade 24. Most preferably the arms 30 are adapted to be held together by a bolt 34 extending there through the arms 30 and the blade 24. Blade bottom portion position guides 40, 42 are welded respectively in front of 40 and on opposite ends 42 of the channel 27 to maintain the blade bottom portion centrally on the channel 27.

Most preferably there are two parallel rows of teeth 32, one row 33 of teeth 32 extends downwardly from a front portion of the channel 26, and the other row of teeth 35 extends downwardly from a rear portion of the channel 26. The teeth 32 in the front row 33 are staggered from the teeth 32 in the rear row 35 so that the ground (not shown) will be raked more finely.

Most preferably the teeth 32 have a threaded top portion so that they may be easily replaced when worn. In the most preferred embodiment of the invention the teeth 32 comprise hardened replaceable bolts 36. If it is desired the heads of the bolts 36 may be ground off to a point. (not shown) In the most preferred embodiment of the invention the channel is 8″ wide by 8′ long. In the most preferred embodiment of the invention the arms 30 are made from flat bar.

In use the rake 20 is positioned parallel to and centered under the blade 24. The blade 24 is hydraulically lowered and seated thereon. The arms 30, now surrounding the blade 24 are then bolted together through the blade 24. The rake 20 then can be carried with the blade 24 on the tractor (not shown). In operation the rake 20 can be hydraulically lowered and pressed into the ground, gravel, etc. (none shown) being raked.

While the invention has been described with preferred specific embodiments thereof, it will be understood that this description is intended to illustrate and not to limit the scope of the invention. The optimal dimensional relationships for all parts of the invention are to include all variations in size, materials, shape, form, function, assembly, and operation, which are deemed readily apparent and obvious to one skilled in the art. All equivalent relationships to those illustrated in the drawings, and described in the specification, are intended to be encompassed in this invention. What is desired to be protected is defined by the following claims.

I claim:

1. A rake for attachment to a horizontally elongated blade comprising:
a horizontally elongate member adapted to be carried adjacent, parallel to, and beneath the bottom portion of the blade;
blade attachment means affixed along the elongate member for releasably attaching the member beneath the bottom portion of the blade; and,
teeth spaced along and extending downwardly beneath the elongate member.

2. A rake as in claim 1 wherein the elongate member comprises a channel.

3. A rake as in claim 2 wherein the attachment means comprises two upright arms, one extending from a front side portion of the elongate member, and one extending from a rear opposite side portion of the elongate member so that when the blade is seated on the elongate member a top portion of the arms may be held together around the blade.

4. A rake as in claim 3 wherein the arms are adapted to be held together by a bolt extending there through.

5. A rake as in claim 4 wherein the bolt is positioned so that it will additionally extend through the blade.

6. A rake as in claim 5 wherein the arms comprise flat bar.

7. A rake as in claim 6 wherein there are two parallel rows of teeth, one row of teeth extending downwardly from a front portion of the channel, and the other row of teeth extending downwardly from a rear portion of the channel.

8. A rake as in claim 7 wherein the teeth in the front row are staggered from the teeth in the rear row.

9. A rake as in claim 8 wherein the teeth have a threaded top portion so that they may be replaced when worn.

10. A rake as in claim 9 wherein the teeth comprise hardened bolts.
